(19) United States
(12) Patent Application Publication
(10) Pub. No.: US 2026/0168454 A1
(43) Pub. Date: Jun. 18, 2026

(54) VEHICLE CONTROLLER AND VEHICLE CONTROL METHOD

(71) Applicant: TOYOTA JIDOSHA KABUSHIKI KAISHA, Toyota-shi (JP)

(72) Inventor: Yukio KOSEKI, Toyota-shi (JP)

(21) Appl. No.: 19/372,279

(22) Filed: Oct. 29, 2025

(30) Foreign Application Priority Data
Dec. 18, 2024 (JP) 2024-221532

(51) Int. Cl. F02D 41/06; F02D 41/22; F02D 41/38; F02D 43/04; F02N 11/08

(52) U.S. Cl. CPC F02D 41/062; F02D 41/22; F02D 41/38; F02D 43/04; F02N 11/08; F02D 2200/0611

(57) ABSTRACT

A vehicle includes an internal combustion engine configured to use hydrogen as fuel, and an electric motor configured to perform motoring that rotates a crankshaft of the internal combustion engine. A controller is configured to execute a determination process and a ventilation process. The determination process is executed when startup of the internal combustion engine is requested. The determination process determines, based on a predetermined condition, whether a hydrogen concentration in a cylinder of the internal combustion engine is high. The ventilation process is executed when the determination process determines that the hydrogen concentration is high. The ventilation process performs motoring.

### CROSS-REFERENCE TO RELATED APPLICATIONS

This application is based upon and claims the benefit of priority from Japanese Patent Application No. 2024-221532, filed on Dec. 18, 2024, the entire contents of which are incorporated herein by reference.

### BACKGROUND

### 1. Field

The following description relates to a controller for a vehicle and a method for controlling a vehicle.

### 2. Description of Related Art

JP2013-87637A discloses a device that stops engine startup if ignition of fuel leaked into a cylinder is detected before fuel injection into the cylinder is initiated.

In an internal combustion engine that uses hydrogen as fuel, abnormal combustion may occur during engine startup if hydrogen gas remains in a cylinder.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a controller for a vehicle is provided. The vehicle includes an internal combustion engine configured to use hydrogen as fuel, and an electric motor configured to perform motoring that rotates a crankshaft of the internal combustion engine. The controller includes processing circuitry. The processing circuitry is configured to execute a determination process that determines, based on a predetermined condition, whether a hydrogen concentration in a cylinder of the internal combustion engine is higher than an abnormal hydrogen concentration at which abnormal combustion of hydrogen may occur. The determination process is executed in response to a request to start the internal combustion engine. The processing circuitry is configured to execute a ventilation process that performs the motoring. The ventilation process is executed under a condition in which the determination process determines that the hydrogen concentration in the cylinder is higher than the abnormal hydrogen concentration.

In another general aspect, a method for controlling a vehicle is provided. The method includes controlling, in response to a request to start an internal combustion engine configured to use hydrogen as fuel, a motor generator to initiate motoring that rotates a crankshaft of the internal combustion engine; obtaining, after initiating the motoring, a hydrogen concentration in an exhaust passage of the internal combustion engine by using a hydrogen concentration sensor arranged in the exhaust passage; determining whether the obtained hydrogen concentration is greater than a predetermined reference value; controlling, under a condition in which the obtained hydrogen concentration is greater than the predetermined reference value, the motor generator to continue the motoring that rotates the crankshaft of the internal combustion engine, without performing fuel injection or ignition in the internal combustion engine; and starting, under a condition in which the obtained hydrogen concentration is less than or equal to the predetermined reference value, fuel injection and ignition in the internal combustion engine.

In another general aspect, a method for controlling a vehicle is provided. The method includes obtaining, in response to a request to start an internal combustion engine configured to use hydrogen as a fuel, a hydrogen concentration of a blow-by gas flowing through a connecting passage by using a hydrogen concentration sensor arranged in the connecting passage, the connecting passage being disposed for feeding the blow-by gas from a crankcase to an intake passage; determining whether the obtained hydrogen concentration is greater than a predetermined reference value; controlling, under a condition in which the obtained hydrogen concentration is greater than the predetermined reference value, a motor generator to perform motoring that rotates a crankshaft of the internal combustion engine, without performing fuel injection or ignition in the internal combustion engine; and starting, under a condition in which the obtained hydrogen concentration is less than or equal to the predetermined reference value, fuel injection and ignition in the internal combustion engine.

Other features and aspects will be apparent from the following detailed description, the drawings, and the claims.

### BRIEF DESCRIPTION OF THE DRAWINGS

FIG. 1 is a schematic diagram showing the configuration of a vehicle in accordance with a first embodiment.

FIG. 2 is a flowchart illustrating a process executed by a controller of the first embodiment.

FIG. 3 is a flowchart illustrating a process executed by a controller of a second embodiment.

FIG. 4 is a flowchart illustrating part of a process executed by a controller of a third embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

### First Embodiment

A vehicle control device according to a first embodiment will now be described.

### Configuration of Vehicle

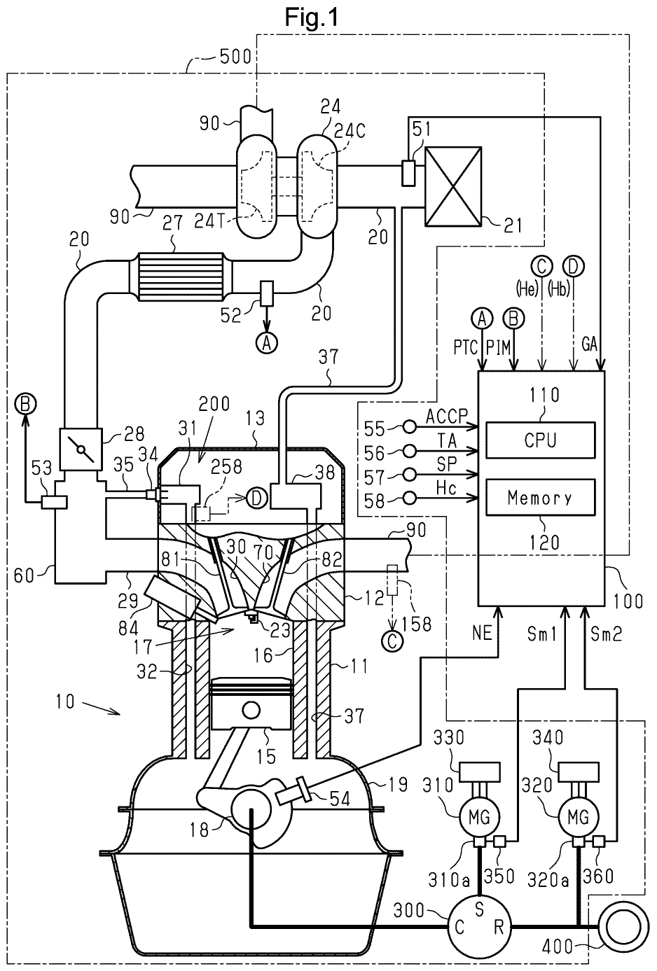

As shown in FIG. 1, an internal combustion engine 10 is mounted in an engine compartment 500 of a vehicle.

The internal combustion engine 10 includes a cylinder block 11, a cylinder head 12, and a head cover 13. The cylinder block 11 includes a cylinder 16 in which a piston 15 is disposed to reciprocate.

The cylinder head 12 includes an intake port 30 that draws intake air into a combustion chamber 17 of the internal combustion engine 10 and an exhaust port 70 that discharges exhaust gas from the combustion chamber 17. The intake port 30 includes an intake valve 81. An exhaust valve 82 is arranged in the exhaust port 70.

The cylinder head 12 includes a fuel injection valve 84 and an ignition plug 23. The fuel injection valve 84 injects hydrogen, which is the amount of fuel of the internal combustion engine 10, into the combustion chamber 17.

A crankcase 19 is provided below the cylinder block 11. The crankcase 19 accommodates a crankshaft 18 of the internal combustion engine 10.

An intake manifold 29 including a surge tank 60 is connected to an upstream portion of the intake port 30. An intake pipe 20 is connected to an upstream portion of the surge tank 60. The surge tank 60 includes an intake pressure sensor 53 that detects an intake pressure PIM. The intake pressure PIM is the pressure in the surge tank 60 and is the pressure in a section of the intake passage downstream of the throttle valve 28.

In the intake pipe 20, an air cleaner 21, an air flow meter 51, a compressor wheel 24C, a boost pressure sensor 52, an intercooler 27, and a throttle valve 28 are arranged in that order from the upstream side. The compressor wheel 24C, the boost pressure sensor 52, the intercooler 27, and the throttle valve 28 are driven by exhaust gas discharged from the combustion chambers 17.

The air cleaner 21 filters intake air drawn into the intake pipe 20. The air flow meter 51 detects an intake air amount GA of the internal combustion engine 10. The compressor wheel 24C of the forced-induction device 24 compresses intake air flowing through the intake passage. The boost pressure sensor 52 detects a boost pressure PTC, which is the pressure in the portion of the intake pipe 20 downstream of the compressor wheel 24C. The intercooler 27 cools the air that has passed through the compressor wheel 24C. The throttle valve 28 regulates the intake air amount of the internal combustion engine 10. The opening degree of the valve is changed by an electric motor.

The air cleaner 21, the intake pipe 20, the surge tank 60, and the intake manifold 29 form an intake passage of the internal combustion engine 10.

An exhaust passage 90 is connected to the downstream side of the exhaust port 70. A housing that accommodates a turbine wheel 24T of the forced-induction device 24 is connected to an intermediate portion of the exhaust passage 90.

The internal combustion engine 10 includes a blow-by gas processing mechanism 200 that introduces, to the intake passage, blow-by gas that has leaked from the combustion chambers 17 into the crankcase 19. The blow-by gas contains, for example, hydrogen, lubricant of the internal combustion engine 10, and combustion gas of air-fuel mixture.

The blow-by gas processing mechanism 200 includes a first connecting passage 37. One of the opposite ends of the first connecting passage 37 is connected to the intake pipe 20 between the air cleaner 21 and the compressor wheel 24C. The first connecting passage 37 extends through the head cover 13 and through the inside of the cylinder head 12 and the cylinder block 11 and is connected to the crankcase 19. A separator 38, which is an oil separator installed in the head cover 13, is provided in the middle of the first connecting passage 37.

The blow-by gas processing mechanism 200 includes a second connecting passage 32 that conducts the blow-by gas in the crankcase 19 to the separator 31, which is an oil separator provided in the head cover 13. The end of the second connecting passage 32, which is connected to the separator 31, opens in the crankcase 19. The separator 31 may be provided in the middle of the second connecting passage 32.

The separators 31 are connected to the surge tank 60 by a differential pressure valve, which is a PCV valve 34, and a PCV passage 35. The PCV valve 34 opens when the pressure in the surge tank 60 is lower than the pressure in the separator 31, thereby allowing blow-by gas to flow from the separator 31 to the surge tank 60. The pressure in the separator 31 is equal to the pressure in the crankcase 19. Thus, the PCV valve 34 is open when the intake pressure IM becomes lower than the pressure in the crankcase 19.

For example, when the operating state of the internal combustion engine 10 is a natural intake state and the intake pressure IM is lower than the atmospheric pressure, the pressure in the surge tank 60 is lower than the pressure in the crankcase 19. This opens the PCV valve 34. When the PCV valve 34 is opened, fresh air flows into the crankcase 19 from the intake pipe 20 via the first connecting passage 37. Blow-by gas in the crankcase 19 is drawn into the surge tank 60 via the second connecting passage 32, the separator 31, the PCV valve 34, and the PCV passage 35. The blow-by gas drawn into the surge tank 60 is delivered to the combustion chamber 17 together with the intake air and burned.

The crankshaft 18 is mechanically coupled to a carrier C of a planetary gear mechanism 300, which is included in a power split device. The planetary gear mechanism 300 includes a sun gear S, which is mechanically coupled to a rotary shaft 310a of the first motor generator 310. The first motor generator 310 functions as a generator that generates power using the engine power output and as a starting starter that performs cranking of the crankshaft 18 at the start of the internal combustion engine 10. The first motor generator 310 is an electric motor that performs motoring to rotate the crankshaft 18.

A rotary shaft 320a of a second motor generator 320 and driven wheels 400 are mechanically coupled to a ring gear R of the planetary gear mechanism 300.

The second motor generator 320 functions as an electric motor that generates a driving force for the driven wheels 400 and as a power generator that generates power through regeneration during deceleration of the vehicle.

Alternating-current voltage of an inverter 330 is applied to terminals of the first motor generator 310. Also, alternating-current voltage of an inverter 340 is applied to terminals of the second motor generator 320. Thus, the vehicle of the present embodiment is a hybrid system vehicle including the internal combustion engine 10 and a motor generator as prime movers.

The controller 100 controls the internal combustion engine 10. The controller 100 operates various devices to be operated such as the throttle valve 28, the fuel injection valve 84, and the ignition plug 23. Also, the controller 100 operates the inverter 330 to control the first motor generator 310. Also, the controller 100 operates the inverter 340 to control the second motor generator 320.

The controller 100 includes, for example, a central processing unit (CPU) 110 that performs calculation processes and a memory 120 that stores programs and data for control. The controller 100 executes processes related to various types of control by causing the CPU 110 to execute programs stored in the memory 120. Although not illustrated, the controller 100 includes multiple control units such as a control unit for the internal combustion engine and a control unit for the first motor generator 310 and the second motor generator 320.

The controller 100 receives detection signals from the air flow meter 51, the boost pressure sensor 52, and the intake pressure sensor 53. The controller 100 also receives detection signals from other sensors. For example, the controller 100 receives a detection signal from a crank angle sensor 54 that detects a rotation angle (crank angle) of the crankshaft 18 to calculate the engine rotation speed NE. Further, the controller 100 receives a detection signal from an accelerator operation amount sensor 55 that detects an accelerator operation amount ACCP. The accelerator operation amount ACCP is the operation amount of the accelerator pedal and adjusts the output of the internal combustion engine 10. The controller 100 also receives a detection signal from a throttle sensor 56 that detects a throttle opening degree TA, which is the opening degree of the throttle valve 28. The controller 100 also receives a detection signal from a vehicle speed sensor 57, which detects a vehicle speed SP of the vehicle. Also, the engine compartment 500 includes a hydrogen concentration sensor 58 that detects hydrogen concentration in the engine compartment 500, which is the hydrogen concentration Hc in the engine compartment 500. The controller 100 receives a detection signal from the hydrogen concentration sensor 58. Further, the controller 100 receives an output signal Sm1 of a first rotation angle sensor 350, which detects a rotation angle of the first motor generator 310. Further, the controller 100 receives an output signal Sm2 of a second rotation angle sensor 360 that detects the rotation angle of the second motor generator 320.

The controller 100 calculates an engine load factor KL based on the engine rotation speed NE and the intake air amount GA. The engine load factor KL is a parameter that determines the amount of air filling the combustion chamber 17, and is the ratio of the inflow air amount per combustion cycle in one cylinder to a reference inflow air amount. The reference inflow air amount is variably set in accordance with the engine speed NE.

Based on the accelerator operation amount ACCP and the vehicle speed SP, the controller 100 calculates a required torque necessary for traveling of the vehicle. Then, the controller 100 controls the requested output Pe of the internal combustion engine 10 and the output torques of the first motor generator 310 and the second motor generator 320 so as to satisfy the requested torque of the vehicle. For example, when the requested output Pe of the internal combustion engine 10 is 0. the controller 100 performs EV traveling, in which the controller 100 stops the operation of the internal combustion engine 10 and uses the output torque of the second motor generator 320 to perform traveling of the vehicle. When the requested output Pe of the internal combustion engine 10 is greater than 0, the controller 100 performs a hybrid traveling, which performs traveling of the vehicle using the engine power output by the internal combustion engine 10 and the output torque of the second motor generator 320.

### Ventilation Inside Cylinder During Engine Startup

Hydrogen, which serves as fuel for the internal combustion engine 10, is in a gas state at room temperature. Therefore, when the engine is not running, a trace of hydrogen gas may leak out of the closed fuel injection valve 84 and remain in the cylinder 16. When the concentration of the hydrogen gas in the cylinder 16 increases, abnormal combustion of the hydrogen gas may occur during engine startup. An example of such abnormal combustion includes autoignition of the hydrogen gas.

Accordingly, the controller 100 is configured to execute the following processes in order to avoid abnormal combustion of the hydrogen gas during engine startup.

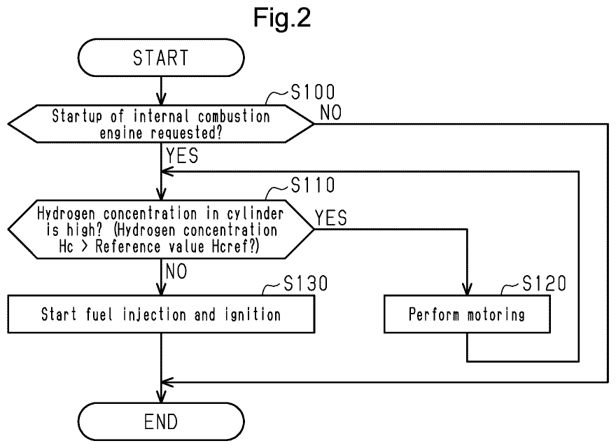

FIG. 2 shows a procedure of a process executed by the controller 100 in predetermined cycles. The process illustrated in FIG. 2 is performed when the CPU 110 executes a program stored in the memory 120 of the controller 100. Hereinafter, the letter “S” preceding a numeral indicates a step number of a process.

When the process shown in FIG. 2 is started, the controller 100 determines whether startup of the internal combustion engine 10 is requested in a state in which the internal combustion engine 10 is not running (S100). This startup request may be performed by operating an ignition switch installed in the passenger compartment of the vehicle or by switching the driving mode from an electric vehicle (EV) mode to a hybrid electric vehicle mode.

When the controller 100 determines that startup of the internal combustion engine 10 is requested in S100 (S100: YES), the controller 100 executes a determination process that determines, based on a predetermined condition, whether the hydrogen concentration in the cylinder 16 (in-cylinder hydrogen concentration) is higher than an abnormal hydrogen concentration at which abnormal combustion may occur (S110). In the determination process of S110, the controller 100 obtains a hydrogen concentration Hc in the engine compartment 500, which is a value detected by the hydrogen concentration sensor 58. When the obtained hydrogen concentration Hc is greater than a predetermined reference value Hcref, the controller 100 determines that the hydrogen concentration in the cylinder 16 is high. When the obtained hydrogen concentration Hc is less than or equal to the reference value Hcref, the controller 100 determines that the hydrogen concentration in the cylinder 16 is not high. The reference value Hcref is a threshold, and is preset to, for example, the lowest value of the hydrogen concentration Hc at which abnormal combustion of hydrogen may occur in the cylinder 16 during engine startup.

When the controller 100 determines that the hydrogen concentration Hc is greater than the reference value Hcref and thus the hydrogen concentration in the cylinder 16 is high in S110 (S110: YES), the controller 100 executes a ventilation process in S120. As the ventilation process, the controller 100 performs motoring that drives the first motor generator 310 to rotate the crankshaft 18.

After S120, the controller 100 executes the determination process of S110 again. In this manner, as long as the controller 100 determines that the hydrogen concentration in the cylinder 16 is high in S110, the controller 100 continues the ventilation process of S120 through motoring. The motoring may be ended if the hydrogen concentration Hc does not become less than or equal to the reference value Hcref even after the motoring is continued for a specified period of time.

When the controller 100 determines that the hydrogen concentration Hc is less than or equal to the reference value Hcref and thus the hydrogen concentration in the cylinder 16 is not high in S110 (S110: NO), the controller 100 executes S130. In S130, the controller 100 executes a process that starts fuel injection and ignition in the internal combustion engine 10. In other words, the controller 100 starts the engine by initiating fuel injection from the fuel injection valves 84 and ignition by the ignition plug 23.

When S130 is executed or when a negative determination is given in S100, the controller 100 ends the process in the present cycle.

### Operation and Advantages of the Present Embodiment

(1-1) The controller 100 executes the determination process of S110 and the ventilation process of S120 illustrated in FIG. 2. The determination process is executed when startup of the internal combustion engine 10 is requested. The determination process determines, based on a predetermined condition, whether the hydrogen concentration in the cylinder 16 of the internal combustion engine 10 is high. The ventilation process is executed when the determination process determines that the hydrogen concentration is high. The ventilation process performs motoring that rotates the crankshaft 18 by the first motor generator 310.

Thus, when it is determined that the hydrogen concentration in the cylinder 16 is high when the start request for the internal combustion engine 10 is issued, motoring is executed. When the motoring is executed, fresh air is drawn into the cylinder 16 so that hydrogen gas in the cylinder 16 is ventilated. This suppresses the abnormal combustion of hydrogen at the start of the engine.
(1-2) The determination process acquires the hydrogen concentration Hc in the engine compartment 500 of the vehicle and determines that the hydrogen concentration in the cylinder 16 is high when the obtained hydrogen concentration Hc exceeds a predetermined reference value Hc.

When the hydrogen concentration in the cylinder 16 is high, the hydrogen gas in the cylinder 16 may leak into the engine compartment 500 from the air cleaner 21 through the intake passage of the internal combustion engine 10. The controller 100 thus obtains the hydrogen concentration Hc in the engine compartment 500. In the determination process of S110, the controller 100 determines that the hydrogen concentration in the cylinder 16 is high when the obtained hydrogen concentration Hc exceeds the reference value Hcref. This allows for appropriate determination of whether the hydrogen concentration in the cylinder 16 is high.
(1-3) When determining in the determination process that the hydrogen concentration is not high (S110: NO), the controller 100 executes the process for initiating fuel injection and ignition of the fuel in the internal combustion engine 10 (S130). Thus, when it is not determined that the hydrogen concentration is high in the determination process of S110, the internal combustion engine 10 is started in accordance with the start request.

### Second Embodiment

A second embodiment of a control device for a vehicle will now be described.

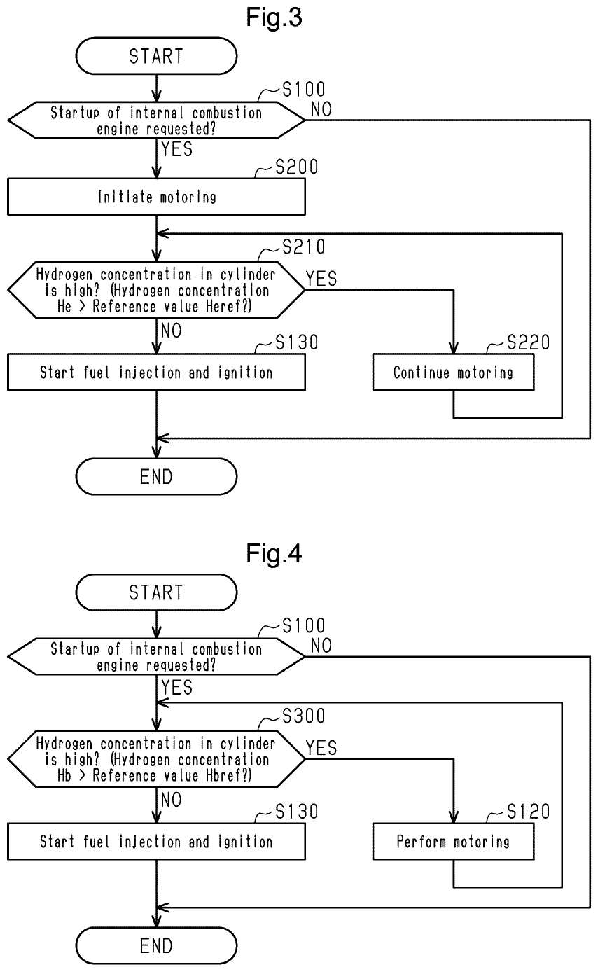

As indicated by double-dashed lines in FIG. 1, an internal combustion engine 10 of the present embodiment includes a hydrogen concentration sensor 158 arranged in the exhaust passage 90 that is connected to the exhaust port 70. The hydrogen concentration sensor 158 detects a hydrogen concentration He in the exhaust passage 90 (exhaust passage hydrogen concentration). The hydrogen concentration sensor 58, which detects the hydrogen concentration Hc in the engine compartment 500, is omitted. The controller 100 is configured to execute a process illustrated in FIG. 3 in predetermined cycles in order to avoid abnormal combustion of the hydrogen gas during engine startup. In the process shown in FIG. 3, the same step numbers are given to those steps that are the same as the process shown in FIG. 2.

When the process shown in FIG. 3 is started, the controller 100 determines whether startup of the internal combustion engine 10 is requested in a state in which the internal combustion engine 10 is not running (S100).

In the process of S100, if it is determined that the start request for the internal combustion engine 10 is made (S100: YES), the controller 100 starts motoring that drives the first motor generator 310 to rotate the crankshaft 18 (S200).

Next, the controller 100 executes a determination process that determines, based on a predetermined condition, whether the hydrogen concentration in the cylinder 16 is high (S210). In S210, the controller 100 obtains the hydrogen concentration He in the exhaust passage 90, which is a value detected by the hydrogen concentration sensor 158. When the obtained hydrogen concentration He is greater than a predetermined reference value Heref, the controller 100 determines that the hydrogen concentration in the cylinder 16 is high. When the obtained hydrogen concentration He is less than or equal to the reference value Heref, the controller 100 determines that the hydrogen concentration in the cylinder 16 is not high. The reference value Heref is a threshold, and is preset to, for example, the lowest value of the hydrogen concentration He at which abnormal combustion of hydrogen may occur in the cylinder 16 during engine startup.

When the controller 100 determines that the hydrogen concentration He is greater than the reference value Heref and thus the hydrogen concentration in the cylinder 16 is high in S210 (S210: YES), the controller 100 continues the motoring initiated in S200 (S220). In the present embodiment, S220 corresponds to a ventilation process that performs the motoring when the determination process determines that the hydrogen concentration is high. Then, the controller 100 executes the determination process of S210 again. In this manner, as long as the controller 100 determines that the hydrogen concentration in the cylinder 16 is high in S210, the above-described ventilation process is continued through the motoring initiated in S200, without starting fuel injection or ignition in the internal combustion engine 10. The motoring may be ended if the hydrogen concentration He does not become less than or equal to the reference value Heref even after the motoring is continued for a specified period of time.

In the determination process of S210, when it is determined that the hydrogen concentration in the cylinder 16 is not high due to the hydrogen concentration Ae being less than or equal to the reference value Heref (S210: NO), the controller 100 executes the process of S130. In S130, the controller 100 executes a process that starts fuel injection and ignition in the internal combustion engine 10.

When S130 is executed or when a negative determination is given in S100, the controller 100 ends the process in the present cycle.

### Operation and Advantages of the Present Embodiment

(2-1) The controller 100 executes the determination process of S210 and the ventilation process of S220 shown in FIG. 3. The determination process is executed when startup of the internal combustion engine 10 is requested. The determination process determines, based on a predetermined condition, whether the hydrogen concentration in the cylinder 16 of the internal combustion engine 10 is high. The ventilation process is executed when the determination process determines that the hydrogen concentration is high. The ventilation process performs motoring that rotates the crankshaft 18 by the first motor generator 310.

Thus, when it is determined that the hydrogen concentration in the cylinder 16 is high when the start request for the internal combustion engine 10 is issued, motoring is executed. When the motoring is executed, fresh air is drawn into the cylinder 16 so that hydrogen gas in the cylinder 16 is ventilated. Thus, the present embodiment suppresses the abnormal combustion of hydrogen at engine start.
(2-2) Before executing the process of S210, the controller 100 executes the process of S200. The determination process obtains the hydrogen concentration He in the exhaust passage 90 and determines that the hydrogen concentration in the cylinder 16 is high when the obtained hydrogen concentration He exceeds a predetermined reference value Heiref.

When the motoring is started in the process of S200, gas remaining in the cylinder 16 is discharged to the exhaust passage 90. Thus, when the hydrogen concentration in the cylinder 16 is high, the hydrogen concentration He in the exhaust passage 90 after the motoring is executed increases. Thus, before executing the process of S210, the controller 100 starts the motoring. Then, the controller 100 obtains the hydrogen concentration He in the exhaust passage 90. In the determination process of S210, the controller 100 determines that the hydrogen concentration in the cylinder 16 is high when the obtained hydrogen concentration He exceeds the reference value Heiref. This allows for appropriate determination of whether the hydrogen concentration in the cylinder 16 is high.
(2-3) When determining in the determination process that the hydrogen concentration is not high (S210: NO), the controller 100 executes the process for initiating fuel injection and ignition of the fuel in the internal combustion engine 10 (S130). Thus, when it is not determined that the hydrogen concentration is high in the determination process of S210, the internal combustion engine 10 is started in accordance with the start request.

### Third Embodiment

A third embodiment of a control device for a vehicle will now be described.

As indicated by double-dashed lines in FIG. 1, an internal combustion engine 10 of the present embodiment includes a hydrogen concentration sensor 258 arranged in the second connecting passage 32 of the blow-by gas processing mechanism 200. The hydrogen concentration sensor 258 detects a hydrogen concentration Hb of the blow-by gas (blow-by gas hydrogen concentration). The hydrogen concentration sensor 58, which detects the hydrogen concentration Hc in the engine compartment 500, is omitted.

As shown in FIG. 4, the controller 100 of the present embodiment executes a determination process of S300 shown in FIG. 4, instead of the determination process of S110 shown in FIG. 2.

Specifically, when the controller 100 determines that startup of the internal combustion engine 10 is requested in a state in which the internal combustion engine 10 is not running in S100, the controller 100 executes a determination process that determines, based on a predetermined condition, whether the hydrogen concentration in the cylinder 16 is high (S300). In the determination process of S300, the controller 100 obtains the hydrogen concentration Hb of the blow-by gas, which is a value detected by the hydrogen concentration sensor 258. When the controller 100 determines that the obtained hydrogen concentration Hb is greater than a predetermined reference value Hbref, the controller 100 determines that the hydrogen concentration in the cylinder 16 is high. When the obtained hydrogen concentration Hb is less than or equal to the reference value Hbref, the controller 100 determines that the hydrogen concentration in the cylinder 16 is not high. The reference value Hbref is a threshold, and is preset to, for example, the lowest value of the hydrogen concentration Hb at which abnormal combustion of hydrogen may occur in the cylinder 16 during engine startup.

In the process of S300, when it is determined that the hydrogen concentration Hb is higher than the reference value Hbref, that the hydrogen concentration in the cylinder 16 is high (S300: YES), the controller 100 sequentially executes the processes after S120 in the first embodiment. Thus, the interior of the cylinder 16 is ventilated.

In the determination process of S300, if it is determined that the hydrogen concentration in the cylinder 16 is not high due to the hydrogen concentration Hb being less than or equal to the reference value Hbref (S300: NO), the controller 100 executes the process of S130 in the first embodiment.

### Operation and Advantages of the Present Embodiment

In addition to (1-1) and (1-3) described above, the present embodiment has the following operation and advantages.
(3-1) The determination process is a process that obtains the hydrogen concentration Hb of blow-by gas and determines that the hydrogen concentration in the cylinder 16 is high when the obtained hydrogen concentration Hb is greater than a predetermined reference value Hbref.

When cranking of the internal combustion engine 10 is started in accordance with a request for starting the internal combustion engine 10, blow-by gas introduced into the intake passage via the blow-by gas processing mechanism 200 flows into the cylinder 16. The blow-by gas of the internal combustion engine 10, which uses hydrogen as fuel, contains hydrogen. Thus, when cranking is started, the hydrogen concentration in the cylinder 16 is increased, and abnormal combustion may occur. Thus, the controller 100 obtains the hydrogen concentration Hb of the blow-by gas. Then, in the determination process of S300, the controller 100 determines that the hydrogen concentration in the cylinder 16 is high when the obtained hydrogen concentration Hb exceeds a predetermined reference value Hbref. More specifically, it is determined that the hydrogen concentration in the cylinder 16 is high when blow-by gas flows into the cylinder 16 through cranking. Therefore, it is possible to properly determine whether the hydrogen concentration in the cylinder 16 is high.

### Modified Examples

The above-described embodiments may be modified as follows. The above-described embodiments and the following modifications can be combined as long as the combined modifications remain technically consistent with each other.

The hydrogen concentration sensor 58 may be changed to a hydrogen leak detector that outputs a signal indicating that the hydrogen concentration Hc is greater than the reference value Hcref.

The hydrogen concentration sensor 158 may be changed to a hydrogen leakage detector that outputs a signal indicating that the hydrogen concentration He is higher than the reference value Heiref.

The hydrogen concentration sensor 258 may be changed to a hydrogen leak detector that outputs a signal indicating that the hydrogen concentration Hb is greater than the reference value Hbref.

The location of the hydrogen concentration sensor 258 in the second embodiment may be changed as long as it can detect the hydrogen concentration Hb of blow-by gas. For example, the hydrogen concentration sensor 258 may be provided on another member constituting the blow-by gas processing mechanism 200. Further, the hydrogen concentration sensor 258 may be located in the crankcase 19.

The internal combustion engine 10 does not necessarily have to include the forced-induction device 24.

The vehicle hybrid system is not limited to the one shown in FIG. 1 and may include other hybrid systems.

The number of motor generators included in the vehicle may be changed.

The vehicle may include only the internal combustion engine 10 as a prime mover. In this modification, the motoring described above may be executed by, for example, driving a starter motor that rotates the crankshaft 18 when the engine is started.

The internal combustion engine 10 may include a fuel injection valve that injects fuel into the intake port 30.

The controller 100 is not limited to a device that includes a CPU and a memory module and executes software processing. For example, the controller 100 may include a dedicated hardware circuit such as an application specific integrated circuit (ASIC) that executes at least part of the processes executed by the software in the above-described embodiment. That is, the controller 100 may be processing circuitry that includes any one of the following configurations (a) to (c). (a) Processing circuitry including at least one processor that executes all of the above-described processes according to programs and at least one program storage device such as a ROM that stores the programs. (b) Processing circuitry including at least one processor and at least one program storage device that execute part of the above-described processes according to the programs and at least one dedicated hardware circuit that executes the remaining processes. (c) Processing circuitry including at least dedicated hardware circuit that executes all of the above-described processes. The program storage device, which is a computer-readable medium, includes any type of media that is accessible by general-purpose computers and dedicated computers.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A controller for a vehicle, the vehicle including an internal combustion engine configured to use hydrogen as fuel, and an electric motor configured to perform motoring that rotates a crankshaft of the internal combustion engine, the controller comprising:
processing circuitry, wherein
the processing circuitry is configured to execute a determination process that determines, based on a predetermined condition, whether a hydrogen concentration in a cylinder of the internal combustion engine is higher than an abnormal hydrogen concentration at which abnormal combustion of hydrogen may occur, the determination process being executed in response to a request to start the internal combustion engine, and
the processing circuitry is configured to execute a ventilation process that performs the motoring, the ventilation process being executed under a condition in which the determination process determines that the hydrogen concentration in the cylinder is higher than the abnormal hydrogen concentration.

2. The controller according to claim 1, wherein the determination process includes:
obtaining a hydrogen concentration in an engine compartment of the vehicle, and
determining that the hydrogen concentration in the cylinder is higher than the abnormal hydrogen concentration when the obtained hydrogen concentration in the engine compartment is greater than a predetermined reference value.

3. The controller according to claim 1, wherein
the processing circuitry is configured to execute a process that initiates the motoring before executing the determination process, and
the determination process includes:
obtaining a hydrogen concentration in an exhaust passage of the internal combustion engine, and
determining that the hydrogen concentration in the cylinder is higher than the abnormal hydrogen concentration when the obtained hydrogen concentration in the exhaust passage is greater than a predetermined reference value.

4. The controller according to claim 1, wherein
the internal combustion engine includes a blow-by gas processing mechanism configured to feed a blow-by gas from a crankcase to an intake passage, and
the determination process includes:
obtaining a hydrogen concentration of the blow-by gas, and
determining that the hydrogen concentration in the cylinder is higher than the abnormal hydrogen concentration when the obtained hydrogen concentration of the blow-by gas is greater than a predetermined reference value.

5. The controller according to claim 1, wherein the processing circuitry is configured to execute a process that starts fuel injection and ignition in the internal combustion engine under a condition in which the determination process determines that the hydrogen concentration in the cylinder is not higher than the abnormal hydrogen concentration.

6. A method for controlling a vehicle, the method comprising:
controlling, in response to a request to start an internal combustion engine configured to use hydrogen as fuel, a motor generator to initiate motoring that rotates a crankshaft of the internal combustion engine;
obtaining, after initiating the motoring, a hydrogen concentration in an exhaust passage of the internal combustion engine by using a hydrogen concentration sensor arranged in the exhaust passage;
determining whether the obtained hydrogen concentration is greater than a predetermined reference value;
controlling, under a condition in which the obtained hydrogen concentration is greater than the predetermined reference value, the motor generator to continue the motoring that rotates the crankshaft of the internal combustion engine, without performing fuel injection or ignition in the internal combustion engine; and
starting, under a condition in which the obtained hydrogen concentration is less than or equal to the predetermined reference value, fuel injection and ignition in the internal combustion engine.

7. A method for controlling a vehicle, the method comprising:
obtaining, in response to a request to start an internal combustion engine configured to use hydrogen as a fuel, a hydrogen concentration of a blow-by gas flowing through a connecting passage by using a hydrogen concentration sensor arranged in the connecting passage, the connecting passage being disposed for feeding the blow-by gas from a crankcase to an intake passage;
determining whether the obtained hydrogen concentration is greater than a predetermined reference value;
controlling, under a condition in which the obtained hydrogen concentration is greater than the predetermined reference value, a motor generator to perform motoring that rotates a crankshaft of the internal combustion engine, without performing fuel injection or ignition in the internal combustion engine; and
starting, under a condition in which the obtained hydrogen concentration is less than or equal to the predetermined reference value, fuel injection and ignition in the internal combustion engine.

8. The method according to claim 7, wherein the connecting passage extends from the crankcase through a cylinder block and a cylinder head to an oil separator, the oil separator being arranged on a head cover that covers the cylinder head.
